(19) United States
(12) Patent Application Publication
(10) Pub. No.: US 2026/0189491 A1
(43) Pub. Date: Jul. 2, 2026

(54) SERVER, COMMUNICATION SYSTEMS, AND TRANSMISSION TIMING CONTROL METHOD

(71) Applicant: NTT, Inc., Tokyo (JP)

(72) Inventors: Hiroshi O, Musashino-shi (JP); Kota ASAKA, Musashino-shi (JP); Tatsuya SHIMADA, Musashino-shi (JP)

(73) Assignee: NTT, Inc., Tokyo (JP)

(21) Appl. No.: 18/859,122

(22) PCT Filed: Apr. 25, 2022
(86) PCT No.: PCT/JP2022/018724

§ 371 Date: Oct. 22, 2024

(51) Int. Cl. H04L 43/0864

(52) U.S. Cl. CPC H04L 43/0864

(57) ABSTRACT

Provided is a server including: a communication unit that transmits a request to each one of a plurality of remote devices to be remotely monitored and receives a response to the request from each remote device; a timing analysis unit that calculates, on the basis of reception times corresponding to a plurality of the responses obtained from the plurality of remote devices, an adjustment time for each remote device for aligning response reception timings of own devices; and a control unit that controls a response transmission timing of each remote device on the basis of the calculated adjustment time for each remote device.

### TECHNICAL FIELD

The present invention relates to a server, a communication system, and a transmission timing control method.

### BACKGROUND ART

Technologies for network quality assurance control in real time have conventionally been proposed. Methods for collecting network quality information include a Request (trigger)-based method and a Subscribe (period)-based method. In conventional NW quality information collection, quality information is collected from a plurality of remote devices by the Request (trigger)-based method or the Subscribe (period)-based method, and the pieces of collected quality information are compared for real-time quality assurance control.

### Citation List

### Non Patent Literature

Non Patent Literature 1: RFC1157, “A Simple Network Management Protocol (SNMP)”, <URL: https://datatracker.ietf.org/doc/html/rfc1157>
Non Patent Literature 2: ITU-T, G.989.3, “40-Gigabit-capable passive optical networks (NG-PON2): Transmission convergence layer specification”

### SUMMARY OF INVENTION

### Technical Problem

However, timings of receiving quality information from the remote devices are not synchronized, and the timings of receiving quality information from the remote devices are not aligned with each other. Accordingly, the quality information used for quality assurance control is not necessarily the latest information. Thus, there has been a problem in that optimal control based on quality information cannot be performed.

In view of the above circumstances, an object of the present invention is to provide a technology capable of performing optimal quality assurance control in a communication network.

### Solution to Problem

One aspect of the present invention provides a server including: a communication unit that transmits a request to each one of a plurality of remote devices to be remotely monitored and receives a response to the request from each remote device; a timing analysis unit that calculates, on the basis of reception times corresponding to a plurality of the responses obtained from the plurality of remote devices, an adjustment time for each remote device for aligning response reception timings of own devices; and a control unit that controls a response transmission timing of each remote device on the basis of the calculated adjustment time for each remote device.

One aspect of the present invention provides a communication system including: a server; a plurality of remote devices remotely monitored by the server; and a plurality of relay devices that relays communication between the server and the plurality of remote devices, in which the server is configured to transmit a request to each one of the plurality of remote devices and receive a response to the request from each remote device, each one of the plurality of remote devices is configured to measure delay time between the server and the remote device, and calculate, on the basis of the measured delay time, an adjustment time for aligning timings at which the responses are received by the server, and each one of the plurality of remote devices or each one of the plurality of relay devices is configured to transmit, to the server, the response to the request transmitted by the server at a timing based on the adjustment time.

One aspect of the present invention provides a transmission timing control method including: transmitting a request to each one of a plurality of remote devices to be remotely monitored, and receiving a response to the request from each remote device; calculating, on the basis of reception times corresponding to a plurality of the responses obtained from the plurality of remote devices, an adjustment time for each remote device for aligning response reception timings of own devices; and controlling a response transmission timing of each remote device on the basis of the calculated adjustment time for each remote device.

### Advantageous Effects of Invention

According to the present invention, it is possible to perform optimal quality assurance control in a communication network.

### BRIEF DESCRIPTION OF DRAWINGS

FIG. 1 A diagram illustrating a configuration example of a communication system 100 according to a first embodiment.

FIG. 2 A sequence diagram illustrating a flow of processing performed by the communication system 100 according to the first embodiment.

FIG. 3 A diagram illustrating a configuration example of a communication system 100a according to a second embodiment.

FIG. 4 A sequence diagram illustrating a flow of processing performed by the communication system 100a according to the second embodiment.

FIG. 5 A diagram illustrating a configuration example of a communication system 100b according to a third embodiment.

FIG. 6 A sequence diagram illustrating a flow of processing performed by the communication system 100b according to the third embodiment.

FIG. 6 A diagram illustrating a configuration example of a communication system 100c according to a fourth embodiment.

### DESCRIPTION OF EMBODIMENTS

Hereinafter, an embodiment of the present invention will be described with reference to the drawings.

### First Embodiment

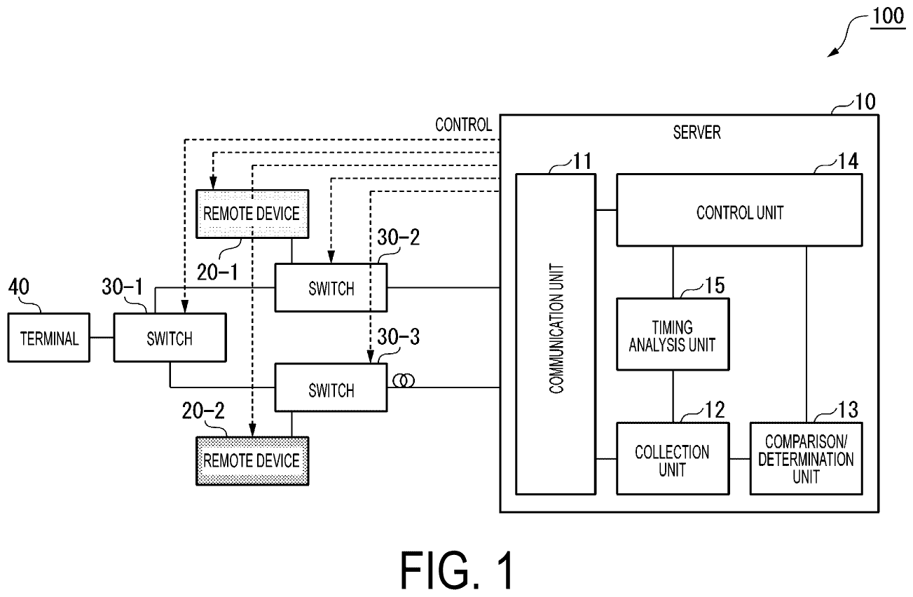

FIG. 1 is a diagram illustrating a configuration example of a communication system 100 according to a first embodiment. The communication system 100 includes a server 10, a plurality of remote devices 20-1 and 20-2, a plurality of switches 30-1 to 30-3, and a terminal 40. The number of remote devices 20 and the number of switches 30 are not limited to the numbers illustrated in FIG. 1. Hereinafter, the remote devices 20-1 and 20-2 will be referred to as the remote devices 20 in a case where the remote devices are not distinguished from each other, and the switches 30-1 to 30-3 will be referred to as the switches 30 in a case where the switches are not distinguished from each other.

In the example illustrated in FIG. 1, the server 10 is connected to the switches 30-2 and 30-3 via transmission paths. The switch 30-2 is connected to the switch 30-1 and the remote device 20-1 via transmission paths. The switch 30-3 is connected to the switch 30-1 and the remote device 20-2 via transmission paths. The switch 30-1 is connected to the switches 30-2 and 30-3 and the terminal 40 via transmission paths. The transmission paths may be optical transmission lines such as optical fibers, or may be electric lines such as coaxial cables. The following description is based on the assumption that the transmission paths are optical transmission lines. Note that the remote devices 20-1 and 20-2 may be connected to the server 10 via the switches 30 through the same path.

The server 10 collects quality information from each of the remote devices 20-1 and 20-2. For example, the server 10 transmits a Request or Subscribe signal to the remote devices 20-1 and 20-2. The server 10 receives Reports individually transmitted from the remote devices 20-1 and 20-2. A Report is a response to a Request or Subscribe signal. The server 10 uses the collected quality information to perform comparison/determination, and controls the path and the remote devices 20-1 and 20-2 on the basis of a result of the determination.

The remote devices 20 are devices to be monitored in a network. Upon receiving a Request or Subscribe signal transmitted from the server 10, the remote devices 20 transmit a Report to the server 10.

The switches 30 switch between paths under the control of the server 10. The switches 30 switch between the paths so as to communicably connect the server 10 and the remote devices 20 or communicably connect the server 10 and the terminal 40. While the switches 30 will be described as optical switches in the following description, the switches 30 may be electrical switches such as L2 switches (L2SW) or L3 switches (L3SW) or routers in a case where electrical communication is performed.

The terminal 40 is a communication device to communicate with the server 10.

Next, a specific configuration of the server 10 will be described. The server 10 includes a communication unit 11, a collection unit 12, a comparison/determination unit 13, a control unit 14, and a timing analysis unit 15.

The communication unit 11 communicates with the remote devices 20 via the switches 30. The communication unit 11 transmits a Request or Subscribe signal to the remote devices 20, and receives a Report from the remote devices 20.

The collection unit 12 collects Reports individually transmitted from the remote devices 20.

The comparison/determination unit 13 acquires, from the collection unit 12, the Reports individually transmitted from the remote devices 20, and uses the acquired Reports to perform quality comparison/determination. The processing performed by the comparison/determination unit 13 is the same as conventional processing. In a case where it is determined that control is necessary as a result of the comparison/determination, the comparison/determination unit 13 notifies the control unit 14 of the details of the control. On the other hand, in a case where it is determined that control is not necessary as a result of the comparison/determination, the comparison/determination unit 13 does not perform anything in particular.

The timing analysis unit 15 compares reception times of signals individually transmitted from the remote devices 20, and calculates, for each remote device 20, an adjustment time for aligning the reception timings with that of the latest signal received. The timing analysis unit 15 notifies the control unit 14 of the calculated adjustment time for each remote device 20.

As another method, the timing analysis unit 15 may align the reception timings with that of another signal. For example, the timing analysis unit 15 may calculate, for each remote device 20, an adjustment time for aligning the reception timings with that of the earliest signal received, or may calculate, for each remote device 20, an adjustment time for aligning the reception timings with that of the middle signal received. In this case, the timing analysis unit 15 may align the reception timings with each other by delaying reception of the Report by one cycle as necessary.

As a method for calculating an adjustment time, the timing analysis unit 15 may be additionally provided with a function of measuring delays between the timing analysis unit 15 and the remote devices 20, and the timing analysis unit 15 may calculate a difference between the measured delay times as the adjustment time.

The control unit 14 generates a Request or Subscribe signal. The control unit 14 controls the communication unit 11 to transmit the generated Request or Subscribe signal to the remote device 20. In a case where an adjustment time for each remote device 20 has been calculated by the timing analysis unit 15, the control unit 14 transmits a Request to each remote device 20 after waiting for the adjustment time. The control unit 14 controls the remote devices 20 and the switches 30 in accordance with the contents of notification received from the comparison/determination unit 13.

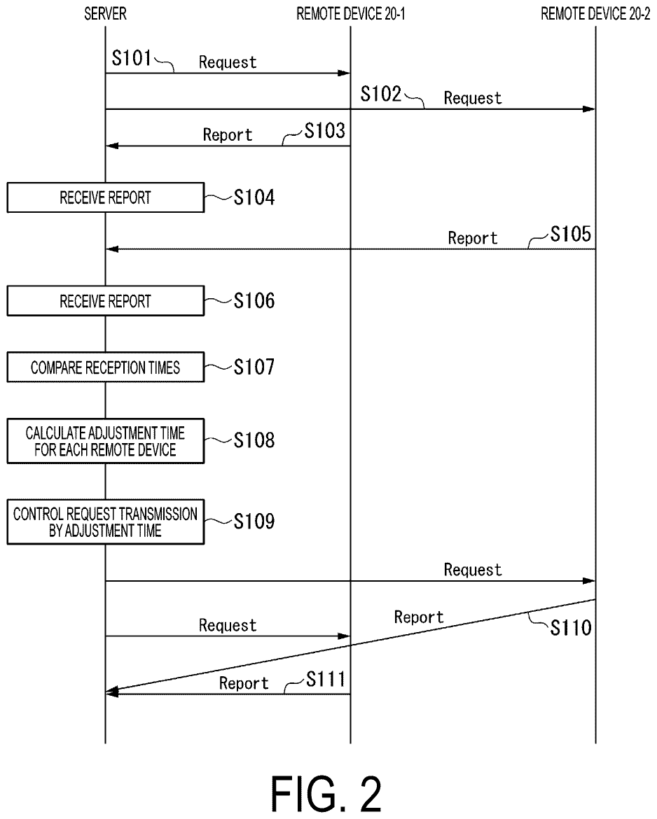

FIG. 2 is a sequence diagram illustrating a flow of processing performed by the communication system 100 according to the first embodiment. In the description of FIG. 2, it is assumed that the distances between the server 10 and the two remote devices 20 (the remote devices 20-1 and 20-2) are different. For example, it is assumed that the distance between the server 10 and the remote device 20-1 is longer than the distance between the server 10 and the remote device 20-2. At the start of the processing in FIG. 2, it is assumed that the server 10 and the remote devices 20 are communicably connected via the switches 30.

The control unit 14 generates Requests addressed to the remote devices 20-1 and 20-2. The control unit 14 outputs, to the communication unit 11, the generated Requests addressed to the remote devices 20-1 and 20-2. The communication unit 11 transmits the Requests to the remote devices 20-1 and 20-2 (step S101 and step S102). While a configuration in which the server 10 transmits a Request to each remote device 20 has been described here, the server 10 may transmit a Subscribe signal to each remote device 20.

The Request transmitted from the server 10 is received by the remote device 20-1 via the switch 30-2. The remote device 20-1 generates a Report in response to reception of the Request. The remote device 20-1 transmits the generated Report to the server 10 (step S103).

The communication unit 11 of the server 10 receives the Report transmitted from the remote device 20-1 (step S104). The communication unit 11 outputs, to the collection unit 12, the received Report and information indicating the time the Report was received. The collection unit 12 outputs, to the timing analysis unit 15, the information indicating the time the Report was received. The remote device 20-2 is located farther from the server 10 than the remote device 20-1. Thus, a Request transmitted from the server 10 is received by the remote device 20-2 at a timing later than reception by the remote device 20-1.

The remote device 20-2 generates a Report in response to reception of the Request. The remote device 20-2 transmits the generated Report to the server 10 (step S105). The communication unit 11 of the server 10 receives the Report transmitted from the remote device 20-2 (step S106). The communication unit 11 outputs, to the collection unit 12, the received Report and information indicating the time the Report was received. The collection unit 12 outputs, to the timing analysis unit 15, the information indicating the time the Report was received.

When the Reports have been received from all the remote devices 20, the timing analysis unit 15 compares the times indicated by the pieces of information indicating the time the Report was received (step S107). Thus, the timing analysis unit 15 calculates an adjustment time for each remote device 20 (step S108). Since the remote device 20-2 is located farther than the remote device 20-1, the adjustment time for each remote device 20 is calculated such that transmission of a Request to the remote device 20-2 is earlier than transmission of a Request to the remote device 20-1. The timing analysis unit 15 outputs, to the control unit 14, information indicating the calculated adjustment time for each remote device 20.

On the basis of the information indicating the adjustment time for each remote device 20 output from the timing analysis unit 15, the control unit 14 causes a Request to be transmitted after waiting for the adjustment time (step S109). For example, the control unit 14 may wait for the adjustment time with the timing at which the information indicating the adjustment time for each remote device 20 was obtained from the timing analysis unit 15 as a reference, or may wait for the adjustment time with another timing as a reference. When the adjustment time corresponding to the remote device 20-2 has elapsed, the control unit 14 generates a Request addressed to the remote device 20-2. The control unit 14 outputs, to the communication unit 11, the generated Request addressed to the remote device 20-2. The communication unit 11 transmits the Request to the remote device 20-2.

The Request transmitted from the server 10 is received by the remote device 20-2 via the switch 30-3. The remote device 20-2 generates a Report in response to reception of the Request. The remote device 20-2 transmits the generated Report to the server 10 (step S110). On the other hand, when the adjustment time corresponding to the remote device 20-1 has elapsed, the control unit 14 generates a Request addressed to the remote device 20-1. The control unit 14 outputs, to the communication unit 11, the generated Request addressed to the remote device 20-1. The communication unit 11 transmits the Request to the remote device 20-1.

The Request transmitted from the server 10 is received by the remote device 20-1 via the switch 30-2. The remote device 20-1 generates a Report in response to reception of the Request. The remote device 20-1 transmits the generated Report to the server 10 (step S111). Thus, transmission of a Report to each remote device 20 is delayed in accordance with the adjustment time for each remote device 20. Thus, the server 10 can receive the Reports individually transmitted from the remote devices 20 at the same timing.

According to the communication system 100 configured as described above, the server 10 controls a response transmission timing of each remote device 20 on the basis of the adjustment time calculated for each remote device 20. For example, the server 10 adjusts the timing of transmitting a Request to each remote device 20 on the basis of the adjustment time calculated for each remote device 20. For example, the server 10 causes a Request to be transmitted to the remote device 20-1 at the timing when the adjustment time corresponding to the remote device 20-1 has elapsed, and causes a Request to be transmitted to the remote device 20-2 at the timing when the adjustment time corresponding to the remote device 20-2 has elapsed. Thus, each remote device 20 receives the Request with a delay of the adjustment time. As a result, Report generation and the Report transmission time are delayed in each remote device 20. However, adjustment is performed on the basis of the adjustment time for each remote device 20 such that the timings at which Reports from the remote devices 20 are received by the server 10 are aligned with each other, and this results in aligning the timings of reception by the server 10 with each other. The timings at which pieces of quality information from the remote devices 20 are received by the server 10 are aligned with each other, and this ensures that the quality information used for quality assurance control is the latest information. It is therefore possible to perform optimal quality assurance control in a communication network.

### second Embodiment

A second embodiment describes a configuration in which, when a Request is transmitted after calculation of an adjustment time, a remote device is also notified of the adjustment time.

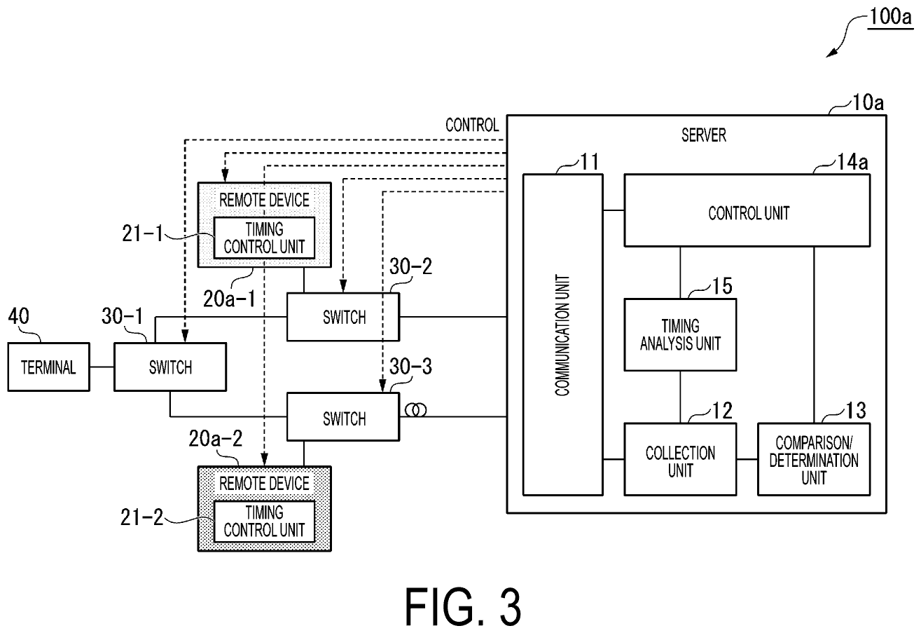

FIG. 3 is a diagram illustrating a configuration example of a communication system 100a according to the second embodiment. The communication system 100a includes a server 10a, a plurality of remote devices 20a-1 and 20a-2, a plurality of switches 30-1 to 30-3, and a terminal 40.

The communication system 100a is different from the communication system 100 in including the server 10a and remote devices 20a instead of the server 10 and the remote devices 20. The other components of the communication system 100a are similar to those of the communication system 100. Hereinafter, differences from the communication system 100 will be described.

The server 10a includes a communication unit 11, a collection unit 12, a comparison/determination unit 13, a control unit 14a, and a timing analysis unit 15.

The control unit 14a generates a Request or Subscribe signal. The control unit 14a controls the communication unit 11 to transmit the generated Request or Subscribe signal to the remote device 20a. In a case where an adjustment time for each remote device 20a has been calculated by the timing analysis unit 15, the control unit 14a causes information indicating the adjustment time to be also transmitted when a Request is transmitted to each remote device 20a. The adjustment time is calculated for each remote device 20a. Thus, the control unit 14a causes information indicating the adjustment time corresponding to each remote device 20a to be transmitted together with the Request for each remote device 20a. The control unit 14a controls the remote devices 20a and the switches 30 in accordance with the contents of notification received from the comparison/determination unit 13.

In a case where the server 10a transmits a Subscribe signal, the control unit 14a notifies each remote device 20a of the calculated adjustment time as new Subscribe information, together with the Subscribe signal.

The remote device 20a-1 includes a timing control unit 21-1. Similarly, the remote device 20a-2 includes a timing control unit 21-2. Hereinafter, the timing control units 21-1 and 21-2 will be referred to as the timing control units 21 in a case where the timing control units are not distinguished from each other.

The timing control unit 21 is activated in response to reception of a Request, and waits for the adjustment time of which the server 10a has notified, with the time point of the activation as a reference. The timing control unit 21 gives an instruction to generate a Report at the timing when the adjustment time of which the server 10a has notified has elapsed. The remote device 20a generates a Report at the timing when the instruction is given from the timing control unit 21, and transmits the generated Report to the server 10a. In a case where the adjustment time is included in the Subscribe signal, the remote device 20a waits for the adjustment time from the time at which the Report should have been transmitted and then transmits the Report.

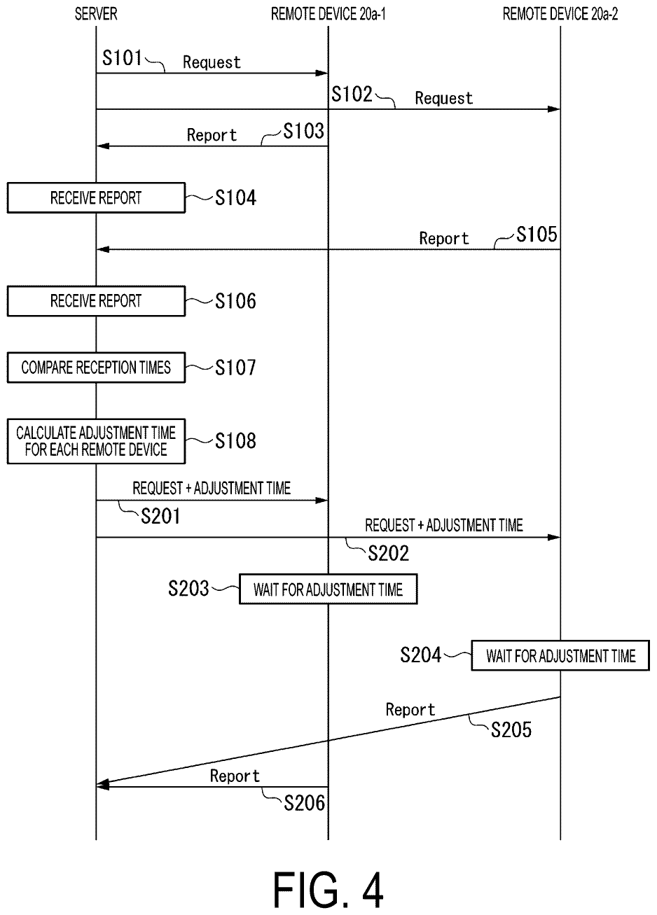

FIG. 4 is a sequence diagram illustrating a flow of processing performed by the communication system 100a according to the second embodiment. In the description of FIG. 4, it is assumed that the distances between the server 10a and the two remote devices 20a (the remote devices 20a-1 and 20a-2) are different. For example, it is assumed that the distance between the server 10a and the remote device 20a-1 is longer than the distance between the server 10a and the remote device 20a-2. At the start of the processing in FIG. 4, it is assumed that the server 10a and the remote devices 20a are communicably connected via the switches 30. In FIG. 4, the same processing steps as those in FIG. 2 are denoted by the same reference numerals as those used in FIG. 2, and description thereof will be omitted.

After the processing from step S101 to step S108 has been executed, the control unit 14a causes information indicating the adjustment time for each remote device 20a output from the timing analysis unit 15 to be transmitted together with transmission of a Request. Specifically, the control unit 14a generates a Request addressed to the remote device 20a-1, and outputs, to the communication unit 11, the generated Request addressed to the remote device 20a-1 and information indicating the adjustment time for the remote device 20a-1. The communication unit 11 transmits, to the remote device 20a-1, the Request addressed to the remote device 20a-1 and the information indicating the adjustment time for the remote device 20a-1 (step S201).

Furthermore, the control unit 14a generates a Request addressed to the remote device 20a-2, and outputs, to the communication unit 11, the generated Request addressed to the remote device 20a-2 and information indicating the adjustment time for the remote device 20a-2. The communication unit 11 transmits, to the remote device 20a-2, the Request addressed to the remote device 20a-2 and the information indicating the adjustment time for the remote device 20a-2 (step S202). The Request and the adjustment time information transmitted from the server 10a are received by the remote device 20a-1 via the switch 30-2. The Request and the adjustment time information transmitted from the server 10a are received by the remote device 20a-2 via the switch 30-3.

The timing control unit 21-1 of the remote device 20a-1 is activated in response to reception of the Request, and waits until the time indicated by the adjustment time information elapses since the time of the activation (step S203). The timing control unit 21-2 of the remote device 20a-2 is activated in response to reception of the Request, and waits until the time indicated by the adjustment time information elapses since the time of the activation (step S204).

The adjustment time for the remote device 20a-2 is shorter than the adjustment time for the remote device 20a-1. Thus, the remote device 20a-2 transmits the Report to the server 10a earlier than the remote device 20a-1. Specifically, the timing control unit 21-2 of the remote device 20a-2 gives an instruction to generate a Report at the timing when the time indicated by the adjustment time information has elapsed. The remote device 20a-2 generates a Report in accordance with the instruction. Thereafter, the remote device 20a-2 transmits the generated Report to the server 10a (step S205).

The timing control unit 21-1 of the remote device 20a-1 gives an instruction to generate a Report at the timing when the time indicated by the adjustment time information has elapsed. The remote device 20a-1 generates a Report in accordance with the instruction. Thereafter, the remote device 20a-1 transmits the generated Report to the server 10a (step S206). Thus, each remote device 20a delays the timing of transmitting the Report in accordance with the adjustment time for each remote device 20a. Thus, the server 10a can receive the Reports individually transmitted from the remote devices 20a at the same timing.

According to the communication system 100a configured as described above, when transmitting a Request, the server 10a also transmits the adjustment time for each remote device 20a. Thus, on the basis of the received adjustment time information, each remote device 20a waits to transmit the Report until the adjustment time elapses since the time point at which the Request was received. Then, the remote device 20a transmits the Report to the server 10a at the timing when the adjustment time has elapsed since the time point at which the Request was received. In this manner, the server 10a controls the Report transmission timing of each remote device 20a. Adjustment is performed on the basis of the adjustment time for each remote device 20a such that the timings at which Reports from the remote devices 20a are received by the server 10a are aligned with each other, and this results in aligning the timings of reception by the server 10a with each other. The timings at which pieces of quality information from the remote devices 20a are received by the server 10a are aligned with each other, and this ensures that the quality information used for quality assurance control is the latest information. It is therefore possible to perform optimal quality assurance control in a communication network.

### Third Embodiment

A third embodiment describes a configuration in which absolute time synchronization is performed between a server and a remote device, and Report transmission time for the remote device is designated in Request transmission. The reference time in the absolute time synchronization is the time of the server.

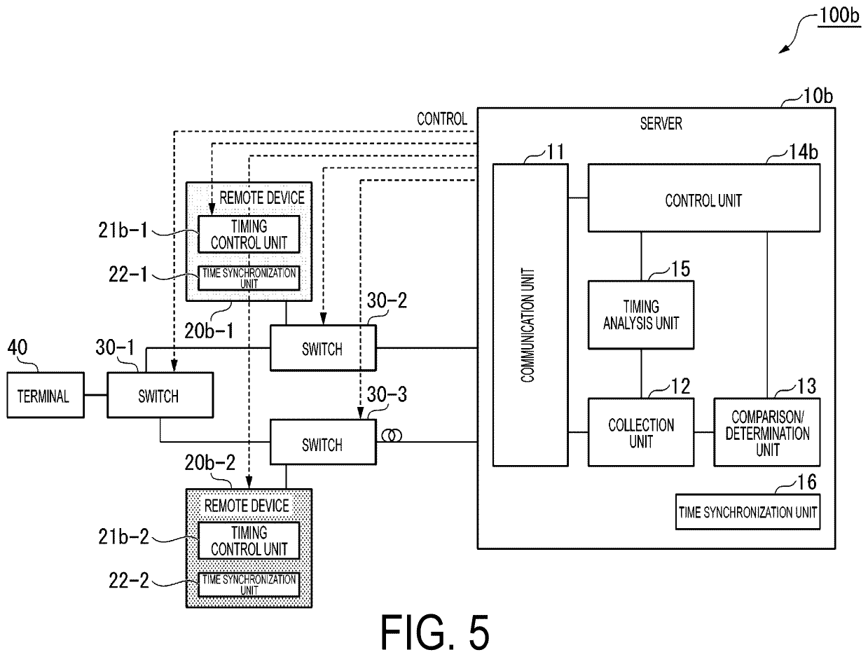

FIG. 5 is a diagram illustrating a configuration example of a communication system 100b according to the third embodiment. The communication system 100b includes a server 10b, a plurality of remote devices 20b-1 and 20b-2, a plurality of switches 30-1 to 30-3, and a terminal 40.

The communication system 100b is different from the communication system 100 in including the server 10b and the remote devices 20b instead of the server 10 and the remote devices 20. The other components of the communication system 100b are similar to those of the communication system 100. Hereinafter, differences from the communication system 100 will be described.

The server 10b includes a communication unit 11, a collection unit 12, a comparison/determination unit 13, a control unit 14b, a timing analysis unit 15, and a time synchronization unit 16.

The time synchronization unit 16 performs time synchronization between the server 10b and the remote devices 20b. In the third embodiment, absolute time synchronization between the server 10b and the remote devices 20b is performed by the time synchronization unit 16.

The control unit 14b generates a Request or Subscribe signal. The control unit 14b controls the communication unit 11 to transmit the generated Request or Subscribe signal to the remote device 20b. In a case where an adjustment time for each remote device 20b has been calculated by the timing analysis unit 15, the control unit 14b causes information indicating the Report transmission time, in which the adjustment time is taken into consideration, to be also transmitted when a Request is transmitted to each remote device 20b. The adjustment time is calculated for each remote device 20b. Thus, the control unit 14b causes the information indicating the Report transmission time to be transmitted for each remote device 20b together with the Request for each remote device 20b. The control unit 14b controls the remote devices 20b and the switches 30 in accordance with the contents of notification received from the comparison/determination unit 13.

In a case where the server 10b transmits a Subscribe signal, the control unit 14b notifies each remote device 20b of the Report transmission time, in which the calculated adjustment time is taken into consideration, as new Subscribe information, together with the Subscribe signal.

The remote device 20b-1 includes a timing control unit 21b-1 and a time synchronization unit 22-1. Similarly, the remote device 20b-2 includes a timing control unit 21b-2 and a time synchronization unit 22-2. Hereinafter, the timing control units 21b-1 and 21b-2 will be referred to as the timing control units 21b in a case where the timing control units are not distinguished from each other. The time synchronization units 22-1 and 22-2 will be referred to as the time synchronization units 22 in a case where the time synchronization units are not distinguished from each other.

The time synchronization units 22 perform time synchronization between the server 10b and the remote devices 20b. In the third embodiment, absolute time synchronization between the server 10b and the remote devices 20b is performed by the time synchronization units 22.

The timing control unit 21b is activated in response to reception of a Request, and waits until the Report transmission time of which the server 10b has notified. The timing control unit 21b gives an instruction to generate a Report at the timing when the Report transmission time of which the server 10b has notified comes. The remote device 20b generates a Report at the timing when the instruction is given from the timing control unit 21b, and transmits the generated Report to the server 10b. In a case where the Report transmission time is included in the Subscribe signal, the remote device 20b similarly transmits a Report to the server 10b at the designated Report transmission time.

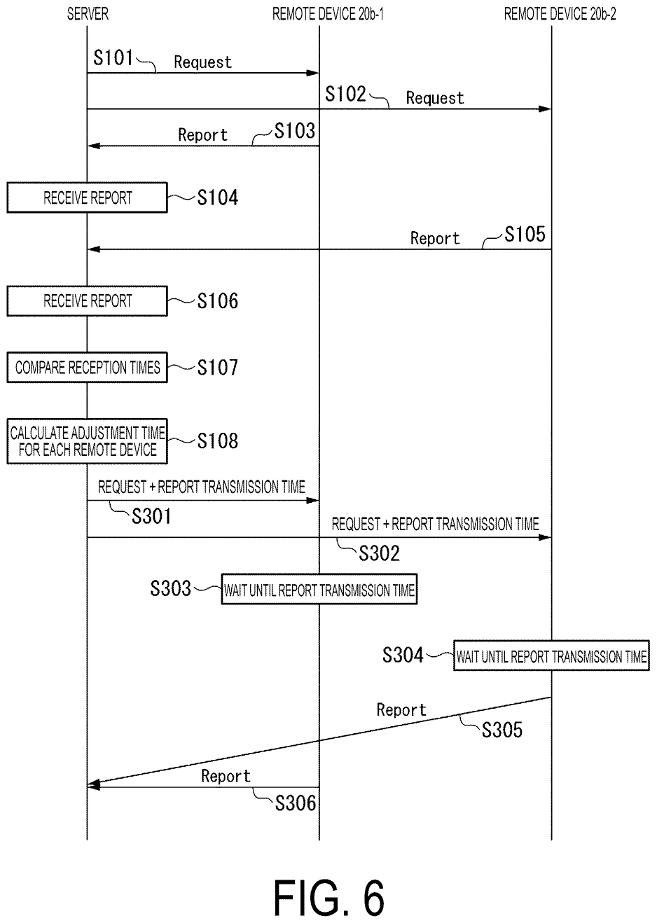

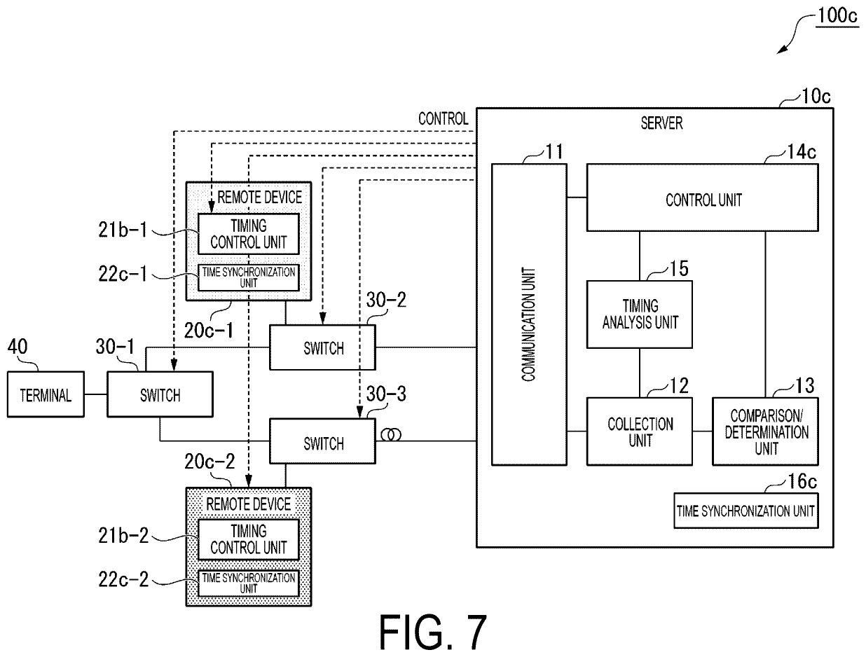

FIG. 6 is a sequence diagram illustrating a flow of processing performed by the communication system 100b according to the third embodiment. In the description of FIG. 6, it is assumed that the distances between the server 10b and the two remote devices 20b (the remote devices 20b-1 and 20b-2) are different. For example, it is assumed that the distance between the server 10b and the remote device 20b-1 is longer than the distance between the server 10b and the remote device 20b-2. At the start of the processing in FIG. 6, it is assumed that the server 10b and the remote devices 20b are communicably connected via the switches 30. In FIG. 6, the same processing steps as those in FIG. 2 are denoted by the same reference numerals as those used in FIG. 2, and description thereof will be omitted.

After the processing from step S101 to step S108 has been executed, the control unit 14b calculates the Report transmission time for each remote device 20b, taking into consideration the adjustment time for each remote device 20b output from the timing analysis unit 15. Then, the control unit 14b causes information indicating the Report transmission time for each remote device 20b to be transmitted together with transmission of a Request. Specifically, the control unit 14b generates a Request addressed to the remote device 20b-1, and outputs, to the communication unit 11, the generated Request addressed to the remote device 20b-1 and information indicating the Report transmission time in which the adjustment time for the remote device 20b-1 is taken into consideration. The communication unit 11 transmits, to the remote device 20b-1, the Request addressed to the remote device 20b-1 and the information indicating the Report transmission time in which the adjustment time for the remote device 20b-1 is taken into consideration (step S301).

Furthermore, the control unit 14b generates a Request addressed to the remote device 20b-2, and outputs, to the communication unit 11, the generated Request addressed to the remote device 20b-2 and information indicating the Report transmission time in which the adjustment time for the remote device 20b-2 is taken into consideration. The communication unit 11 transmits, to the remote device 20b-2, the Request addressed to the remote device 20b-2 and the information indicating the Report transmission time in which the adjustment time for the remote device 20b-2 is taken into consideration (step S302). The Request and the information indicating the Report transmission time transmitted from the server 10b are received by the remote device 20b-1 via the switch 30-2. The Request and the information indicating the Report transmission time transmitted from the server 10b are received by the remote device 20b-2 via the switch 30-3.

The timing control unit 21b-1 of the remote device 20b-1 is activated in response to reception of the Request, and waits until the Report transmission time (step S303). The timing control unit 21b-2 of the remote device 20b-2 is activated in response to reception of the Request, and waits until the Report transmission time (step S304).

It is assumed that the Report transmission time for the remote device 20b-2 is set to time earlier than the Report transmission time for the remote device 20b-1. Thus, the remote device 20b-2 transmits the Report to the server 10b earlier than the remote device 20b-1. Specifically, the timing control unit 21b-2 of the remote device 20b-2 gives an instruction to generate a Report at the timing when the Report transmission time comes. The remote device 20b-2 generates a Report in accordance with the instruction. Thereafter, the remote device 20b-2 transmits the generated Report to the server 10b (step S305).

The timing control unit 21b-1 of the remote device 20b-1 gives an instruction to generate a Report at the timing when the Report transmission time comes. The remote device 20b-1 generates a Report in accordance with the instruction. Thereafter, the remote device 20b-1 transmits the generated Report to the server 10b (step S306).

According to the communication system 100b configured as described above, when transmitting a Request, the server 10b also transmits the information indicating the Report transmission time in which the adjustment time for each remote device 20b is taken into consideration. Thus, on the basis of the received information indicating the Report transmission time, each remote device 20b waits to transmit the Report until the Report transmission time. Then, the remote device 20b transmits the Report to the server 10b at the timing when the Report transmission time comes. In this manner, the server 10b controls the Report transmission timing of each remote device 20b. Adjustment is performed on the basis of the adjustment time for each remote device 20b such that the timings at which Reports from the remote devices 20b are received by the server 10b are aligned with each other, and this results in aligning the timings of reception by the server 10b with each other. The timings at which pieces of quality information from the remote devices 20b are received by the server 10b are aligned with each other, and this ensures that the quality information used for quality assurance control is the latest information. It is therefore possible to perform optimal quality assurance control in a communication network.

### Fourth Embodiment

A fourth embodiment describes a configuration in which relative time synchronization is performed between a server and a remote device, and Report transmission time for the remote device is designated in Request transmission. Here, relative time synchronization means that a Request includes transmission time of the signal from the server, and when receiving the signal, the remote device synchronizes the time of the remote device with the transmission time of the signal. Alternatively, a signal other than a Request may be used.

FIG. 7 is a diagram illustrating a configuration example of a communication system 100c according to the fourth embodiment. The communication system 100c includes a server 10c, a plurality of remote devices 20c-1 and 20c-2, a plurality of switches 30-1 to 30-3, and a terminal 40.

The communication system 100c is different from the communication system 100 in including the server 10c and the remote devices 20c instead of the server 10 and the remote devices 20. The other components of the communication system 100c are similar to those of the communication system 100. Hereinafter, differences from the communication system 100 will be described.

The server 10c includes a communication unit 11, a collection unit 12, a comparison/determination unit 13, a control unit 14c, a timing analysis unit 15, and a time synchronization unit 16c.

The time synchronization unit 16c performs time synchronization between the server 10c and the remote devices 20c. In the fourth embodiment, relative time synchronization between the server 10c and the remote devices 20c is performed by the time synchronization unit 16c.

The control unit 14c generates a Request or Subscribe signal. The control unit 14c controls the communication unit 11 to transmit the generated Request or Subscribe signal to the remote device 20c. In a case where an adjustment time for each remote device 20c has been calculated by the timing analysis unit 15, the control unit 14c causes information indicating the Report transmission time, in which the adjustment time is taken into consideration, to be also transmitted when a Request is transmitted to each remote device 20c. The adjustment time is calculated for each remote device 20c. Thus, the control unit 14c causes the information indicating the Report transmission time to be transmitted for each remote device 20c together with the Request for each remote device 20c. The control unit 14c may calculate the Report transmission time on the basis of the signal transmission time for relative time synchronization, taking into consideration the adjustment time. The control unit 14c controls the remote devices 20c and the switches 30 in accordance with the contents of notification received from the comparison/determination unit 13.

In a case where the server 10c transmits a Subscribe signal, the control unit 14c notifies each remote device 20c of the Report transmission time, in which the calculated adjustment time is taken into consideration, as new Subscribe information, together with the Subscribe signal.

The remote device 20c-1 includes a timing control unit 21b-1 and a time synchronization unit 22c-1. Similarly, the remote device 20c-2 includes a timing control unit 21b-2 and a time synchronization unit 22c-2. Hereinafter, the time synchronization units 22c-1 and 22c-2 will be referred to as the time synchronization units 22c in a case where the time synchronization units are not distinguished from each other.

The time synchronization units 22c perform time synchronization between the server 10c and the remote devices 20c. In the fourth embodiment, relative time synchronization between the server 10c and the remote devices 20c is performed by the time synchronization unit 16c.

The processing in the communication system 100c is similar to the processing illustrated in FIG. 6, except for a difference in calculation of the Report transmission time.

According to the communication system 100c configured as described above, effects similar to those of the third embodiment can be obtained.

### Modification 1

In the first to fourth embodiments, delay times between the server 10 and the remote devices 20 may be measured by the remote devices 20. In a case of this configuration, the remote devices 20 have a delay measurement function of measuring the delay times between the server 10 and the remote devices 20. In the first embodiment, in a case where the delay times between the server 10 and the remote devices 20 are measured by the remote devices 20, each remote device 20 measures the delay time and notifies the server 10 of information indicating the measured delay time. The server 10 may calculate adjustment times by using a plurality of pieces of the information indicating the delay time received from the remote devices 20.

In the second embodiment, in a case where delay times between the server 10a and the remote devices 20a are measured by the remote devices 20a, the remote devices 20a use the measured delay times to calculate adjustment times. The adjustment time is calculated by subtracting the measured delay time from the time designated by the server 10a. The server 10a designates, for the remote devices 20a, the same time or different times depending on the remote device 20a. For example, in a case where Reports are collected from a plurality of the remote devices 20a by time division multiplexing, the server 10a designates different time for each remote device 20a. However, since the delay time is different for each remote device 20a, the adjustment time calculated by each remote device 20a is also different for each remote device 20a. Each remote device 20a waits for the calculated adjustment time, from the timing of receiving a Request or Subscribe signal. Each remote device 20a transmits the Report to the server 10 at the timing when the adjustment time has elapsed.

In the third embodiment, in a case where delay times between the server 10b and the remote devices 20b are measured by the remote devices 20b, the remote devices 20b use the measured delay times to calculate adjustment times. The method for calculating the adjustment time is similar to that described above. Each remote device 20b receives information indicating the same Report transmission time from the server 10a, and each remote device 20b determines time as new Report transmission time, the time being determined on the basis of the Report transmission time indicated by the received Report transmission time information, taking into consideration the adjustment time. Each remote device 20b transmits the Report to the server 10b at the timing when the newly determined Report transmission time comes. The same applies to the fourth embodiment. As described above, in the second to fourth embodiments, the remote device 20a, 20b, or 20c transmits, to the server 10a, 10b, or 10c, a response to a Request or Subscribe signal transmitted from the server 10a, 10b, or 10c, at a timing based on the adjustment time. Here, the timing based on the adjustment time is the timing when the adjustment time has elapsed or the timing when the Report transmission time comes.

### Modification 2

In the second to fourth embodiments described in Modification 1, the Report transmission timing may be adjusted by the switches 30. Each of the remote devices 20a, 20b, and 20c notifies the connected switch 30 of adjustment time information and a Report. Thus, the switch 30 grasps the time and adjusts the transmission timing for Report transmission. Specifically, in the second embodiment, even in a case where a Report has been received from the remote device 20a, the switch 30 does not transmit the Report until the adjustment time elapses. The switch 30 transmits the Report to the server 10a at the timing when the adjustment time has elapsed. In this case, the switch 30 may determine whether the adjustment time has elapsed with the timing at which the Report was received from the remote device 20a as a reference.

In the third embodiment, even in a case where a Report has been received from the remote device 20b, the switch 30 does not transmit the Report until the Report transmission time comes. The switch 30 transmits the Report to the server 10b at the timing when the Report transmission time comes. In this case, notification of the information indicating the Report transmission time may be received from the server 10b or may be received from the remote device 20b. The same applies to the fourth embodiment. As described above, in the second to fourth embodiments, the switch 30 transmits, to the server 10a, 10b, or 10c, a response (here, a Report transmitted from the remote device 20b) to a Request or Subscribe signal transmitted from the server 10a, 10b, or 10c, at a timing based on the adjustment time.

### Modification 3

In the first to fourth embodiments, on the assumption that the next execution timing of the comparison/determination unit 13 is definite, Report reception timings may be aligned with the next execution timing. Here, definite means a case where the execution is periodic, or is non-periodic but the next execution timing is grasped in advance, for example.

Some of the functional units of the servers 10, 10a, 10b, and 10c and the remote devices 20, 20a, 20b, and 20c in the above-described embodiments may be implemented by a computer. In that case, a program for implementing the functions may be recorded in a computer-readable recording medium, and the functions may be implemented by loading the program recorded in this recording medium to a computer system, and executing the program. Note that the “computer system” herein includes an OS and hardware such as peripheral devices.

In addition, the “computer-readable recording medium” refers to a portable medium such as a flexible disk, a magneto-optical disk, a ROM, or a CD-ROM, or a storage device such as a hard disk built in a computer system. Furthermore, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program may be for implementing some of the functions described above, may be capable of implementing the functions described above in combination with a program already recorded in a computer system, or may be implemented using a programmable logic device such as an FPGA.

Although the embodiments of the present invention have been described in detail with reference to the drawings, the specific configurations are not limited to the embodiments, and include design and the like within a range not departing from the gist of the present invention.

### Industrial Applicability

The present invention can be applied to a communication system that collects quality information of a network.

### Reference Signs List

10, 10a, 10b, 10c Server
11 Communication unit
12 Collection unit
Comparison/determination unit
14, 14a, 14b, 14c Control unit
15 Timing analysis unit
16, 16c, 22, 22c, 22-1 to 22-2, 22c-1 to 22c-2 Time synchronization unit
20, 20a, 20b, 20 c, 20-1 to 20-2, 20a-1 to 20a-2, 20b-1 to 20b-2, 20c-1 to 20c-2 Remote device
21, 21b, 21-1 to 21-2, 21b-1 to 21b-2 Timing control unit
30, 30-1 to 30-3 Switch
40 Terminal

1. A server comprising:
a communicator configured to transmit a request to each one of a plurality of remote devices to be remotely monitored and receives a response to the request from each remote device;
a timing analyser configured to calculate, on the basis of reception times corresponding to a plurality of the responses obtained from the plurality of remote devices, an adjustment time for each remote device for aligning response reception timings of own devices; and
a controller configured to control a response transmission timing of each remote device on the basis of the calculated adjustment time for each remote device.

2, The server according to claim 1, wherein
the controller controls the response transmission timing of each remote device by setting a certain timing as a reference and controlling, every time the adjustment time calculated for each remote device elapses since the timing set as the reference, the communicator to transmit the request to the remote device corresponding to the elapsed adjustment time.

3. The server according to claim 1, wherein
the controller controls the response transmission timing of each remote device by controlling the communicator to transmit the adjustment time for each remote device to each remote device, together with transmission of the request to each remote device.

4. The server according to claim 1, wherein
the controller controls the response transmission timing of each remote device by controlling the communicator to transmit, to each remote device, response transmission time for each remote device in which the adjustment time for each remote device is taken into consideration, together with transmission of the request to each remote device.

5. The server according to claim 4, further comprising:
a time synchronizer configured to perform absolute time synchronization, between the server and each remote device, with time of the server,
wherein the controller calculates the response transmission time for each remote device on the basis of time of the own device, taking into consideration the adjustment time for each remote device.

6. The server according to claim 4, further comprising:
a time synchronizer configured to perform relative time synchronization, between the server and each remote device, with time of which each remote device is notified by the server,
wherein the controller calculates the response transmission time for each remote device on the basis of reference time, taking into consideration the adjustment time for each remote device.

7. A communication system comprising: a server; a plurality of remote devices remotely monitored by the server; and a plurality of relay devices that relays communication between the server and the plurality of remote devices,
wherein the server is configured to
transmit a request to each one of the plurality of remote devices and receive a response to the request from each remote device,
each one of the plurality of remote devices is configured to
measure delay time between the server and the remote device, and calculate, on the basis of the measured delay time, an adjustment time for aligning timings at which the responses are received by the server, and
each one of the plurality of remote devices or each one of the plurality of relay devices is configured to
transmit, to the server, the response to the request transmitted by the server at a timing based on the adjustment time.

8. A transmission timing control method comprising:
transmitting a request to each one of a plurality of remote devices to be remotely monitored, and receiving a response to the request from each remote device;
calculating, on the basis of reception times corresponding to a plurality of the responses obtained from the plurality of remote devices, an adjustment time for each remote device for aligning response reception timings of own devices; and
controlling a response transmission timing of each remote device on the basis of the calculated adjustment time for each remote device.
